(19) United States
(12) Patent Application Publication
(10) Pub. No.: US 2006/0075268 A1
(43) Pub. Date: Apr. 6, 2006

(54) Apparatus and method for controlling consumption of battery power in multi-function terminal

(75) Inventors: Hyung-Tae Kim, Seoul (KR); Yeo-Joon Yoon, Seoul (KR); Jung-Cheon Choi, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/244,020

(22) Filed: Oct. 5, 2005

(30) Foreign Application Priority Data
Oct. 6, 2004 (KR) 2004-79523

(51) Int. Cl. G06F 1/26

(52) U.S. Cl. 713/300

(57) ABSTRACT

Disclosed is a battery power consumption control apparatus and a method for controlling the same in a multi-function terminal, which has at least two functions and is supplied with electric power from one battery, the battery consumption control apparatus including a battery information reading unit for reading capacity of the battery; a memory for storing information about function executable time periods assigned to at least two functions equally or differentially according to the functions within an entire capacity range of the battery; and a control unit for controlling a selected function to be performed for only a time period allowed according to corresponding execution time information when a user selects the function.

### PRIORITY

This application claims priority to an application entitled “Apparatus and Method for Controlling Consumption of Battery Power in Multi-function Terminal” filed in the Korean Intellectual Property Office on Oct. 6, 2004 and assigned Ser. No. 2004-79523, the contents of which are incorporated herein by reference.

### BACKGROUND OF THE INVENTION

1. Field of the Invention

The present invention relates to a terminal which uses a battery and has at least two functions, and more particularly to an apparatus and a method for controlling the consumption of battery power that can divide and use battery power according to functions.

2. Description of the Related Art

There are various kinds of mobile communication terminals that provide at least two functions while using a rechargeable battery. A portable phone having both a function of receiving Digital Multimedia Broadcasting (‘DMB’) and a phone function is an appropriate example. A Personal Digital Assistant (‘PDA’) having a DMB reception function, a phone function and a personal information management function is another example. When battery power is completely consumed in these mobile communication terminals, the portable phone is unable to perform the communication function, the PDA loses all data input by the user, except its operation system. Therefore, it is necessary that users remain vigilant and take more care with regard to the discharge of electric power when using the PDA.

The mobile communication terminal using a rechargeable battery as described above has a power consumption limitation due to the limited capacity of the rechargeable battery. Therefore, it is necessary to properly distribute the electric power of the battery with the first primacy given to a chiefly used function.

### SUMMARY OF THE INVENTION

Accordingly, the present invention has been made to solve the above-mentioned problems occurring in conventional systems, and an object of the present invention is to provide an apparatus and a method for controlling the consumption of battery power in a mobile communication terminal that enable the user to equally or differentially assign and set usable amounts from among the entire battery capacity for at least two functions, thereby allowing the electric power to be consumed for each function within the limit of the amount of power assigned to the function.

To accomplish this object, in accordance with one aspect of the present invention, there is provided a battery consumption control apparatus for a terminal which has at least two functions and is supplied with electric power from one battery, the battery consumption control apparatus including a battery information reading unit for reading capacity of the battery; a memory for storing information about function executable time periods assigned to at least two functions equally or differentially according to the functions within a time period available for a capacity of the battery; and a control unit for controlling a selected function to be performed for only a time period allowed according to corresponding execution time information when a user selects the function.

In accordance with another aspect of the present invention, there is provided a method for controlling battery consumption in a terminal which has a first function and a second function and is supplied with electric power from one battery, the method including steps of checking current battery capacity; distributing a time period available for the current battery capacity to a first function executable time period and a second function executable time period; checking battery capacity at every predetermined time interval upon execution of the selected one of the first and second functions starts execution thereof by user's selection and calculating an executable time period for the selected function corresponding to the checked battery capacity; and ending the execution of the selected function when the calculated executable time period is identical to the distributed executable time period of the selected function.

### BRIEF DESCRIPTION OF THE DRAWINGS

The above and other objects, features and advantages of the present invention will be more apparent from the following detailed description taken in conjunction with the accompanying drawings, in which:

FIGS. 1A and 1B are views representing initial menu screens for registering a communication time period in a mobile communication terminal according to an embodiment of the present invention;

FIG. 2 is a view representing an initial menu screen for viewing Digital Multimedia Broadcasting (‘DMB’) in the mobile communication terminal according to an embodiment of the present invention;

FIG. 3 is a view representing a screen for informing a user of the expiration of a DMB viewing time period in the mobile communication terminal according to an embodiment of the present invention;

FIG. 4 is a block diagram illustrating a construction of a mobile communication terminal capable of receiving DMB according to an embodiment of the present invention;

FIG. 5 is a flowchart illustrating a battery setup process for controlling the consumption of battery power using a battery setup menu according to an embodiment of the present invention;

FIG. 6 is a flowchart illustrating a method for controlling DMB viewing according to an embodiment of the present invention, which can control battery power; and

FIG. 7 is a flowchart illustrating a method for controlling DMB viewing according to another embodiment of the present invention, which can control battery power.

### DETAILED DESCRIPTION OF THE PREFERRED EMBODIMENTS

Hereinafter, preferred embodiments according to the present invention will be described with reference to the accompanying drawings. It is to be noted that the same elements are indicated with the same reference numerals throughout the drawings. Although specific periods of time (e.g., one minute, one hour, 40 minutes, etc.) are given below, they are presented for a better understanding of the present invention and are not limiting as to the scope of the invention. Also, it will be clear to those skilled in the art that the present invention can be practiced without such specific features. In the following description of the present invention, a detailed description of known functions and configurations incorporated herein will be omitted to avoid making the subject matter of the present invention unclear.

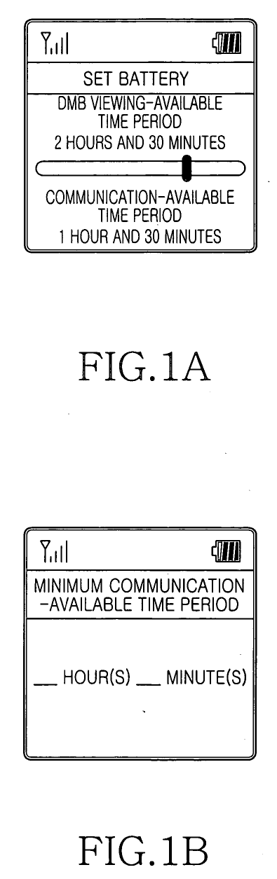

FIGS. 1A and 1B are views representing initial menu screens for registering a communication time period in a mobile communication terminal according to an embodiment of the present invention.

FIG. 1A illustrates a screen representing a communication-available time period and a DMB viewing-available time period. The user can move a bar along a linear adjustment slit displayed on a screen by means of an input unit, so as to optionally set a power portion for the DMB viewing and the other power portion for the communication from among the remaining battery capacity. According to the location that the bar is moved, i.e. to the left or to the right in the linear adjustment slit, a communication-available time period and a DMB viewing-available time period are definitely displayed. FIG. 1A shows a case in which the communication-available time period is one hour and 30 minutes and the DMB viewing-available time period is two hours and 30 minutes. This means that, when a communication-available time period desired (i.e. set) by the user is one hour and 30 minutes, remaining power (except the power required for communication of one hour and 30 minutes) from among current battery capacity can be used to view DMB, and the remaining power enables the user to view DMB for two hours and 30 minutes.

FIG. 1B shows a screen representing only a minimum communication-available time period, which is constructed to allow the user to directly input a minimum communication-available time period by the hour and minute.

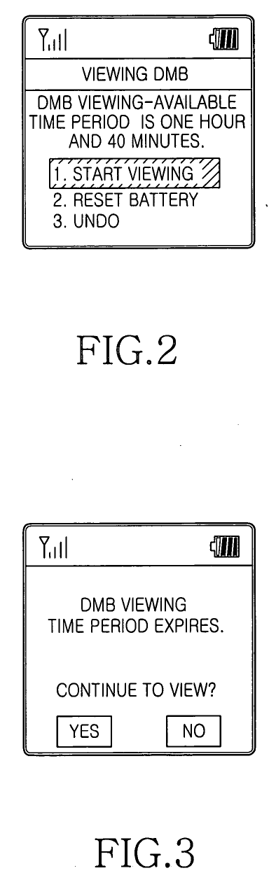

FIG. 2 is a view representing an initial menu screen for viewing DMB in the mobile communication terminal according to an embodiment of the present invention. When the user selects a DMB mode for viewing DMB, a message (such as “DMB viewing-available time period is one hour and 40 minutes”) is displayed together with a menu (such as ‘1. Start viewing’, ‘2. Reset battery’ and ‘3. Undo’) on a screen.

When the user moves a cursor using an input unit and selects ‘1. Start viewing’ from the menu, the reception of DMB starts. Also, when the user selects from the menu ‘2. Reset battery’, a screen in which a ratio between the communication-available time period and the DMB viewing-available time period can be changed by the user is displayed, and when the user selects from the menu ‘3. Undo’, a screen for a typical standby mode of a portable phone is displayed, so as to perform a phone function.

FIG. 3 is a view representing a screen for informing a user of the expiration of a DMB viewing time period in the mobile communication terminal according to an embodiment of the present invention.

When a DMB viewing-available time period (which the user of the mobile communication terminal sets before viewing DMB) elapses, a message such as “DMB viewing time period expires.” is displayed on the screen, thereby notifying the user of the expiration of the DMB viewing time period. In addition, in order to check whether the user wants to continuously view the DMB, a message such as “Continue to view?” is displayed together with button icons of “Yes” and “No” on a lower position of the screen. When the user clicks the “No” button, the screen changes to a mode (e.g., the standby mode) for performing the phone function. In contrast, when the user clicks the “Yes” button, a screen as shown in FIG. 1A is displayed to notify the user of a current time division ratio. In this case, the screen displays the DMB viewing-available time period as being ‘zero’ and the communication-available time period of a value estimated as all currently remaining battery power. Then, the user may reset the DMB viewing-available time period by moving the bar. Alternatively, the user may directly input a minimum necessary communication-available time period by the hour and minute on the input menu screen for a minimum communication-available time period, as shown in FIG. 1B.

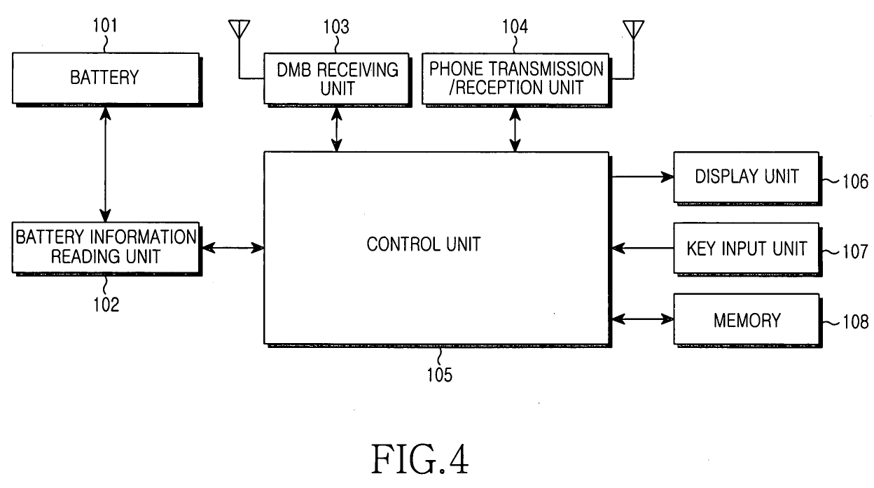

FIG. 4 is a block diagram illustrating a construction of a mobile communication terminal capable of receiving DMB according to an embodiment of the present invention.

A battery 101 supplies electric power to the mobile communication terminal. A battery information reading unit 102 detects the voltage, the capacity, the current and similar information about the battery 101, and outputs detected information. A DMB receiving unit 103 receives DMB signals so that the user may view the DMB. A phone transmission/reception unit 104 wirelessly transmits and receives signals to perform the well-known phone function. A key input unit 107 and a display unit 106 are user interface means for inputting and displaying, respectively, selection of functions or information relating to execution time. A memory 108 stores a battery characteristic table and program data, temporarily stores data generated during operation, and stores information about function executable time periods assigned to at least two functions (e.g., DMB function and phone function) equally or differentially according to the functions within a time period available for the capacity of the battery 101. A control unit 105 controls the operation so that a selected function may be performed only for an available time period included in relevant execution time information corresponding to the selected function when the user selects the function.

To be specific, when the user selects the DMB function, the control unit 105 checks the executable time period for the DMB function in the memory 108, receives DMB signals only for the executable time period, and then automatically enters the standby mode for the phone function. Also, after stopping the reception of DMB, the control unit 105 controls a menu screen (which notifies the expiration of a DMB viewing-available time period, asks the user whether the user wants to continue viewing the DMB and enables the user to respond to the asked question) to be displayed on the display unit 106. In addition, the control unit 105 controls the initial screen for the DMB function to be displayed on the display unit 106, in which the initial screen displays various icons for enabling the user to select one of ‘Start viewing’, ‘Reset battery’ and ‘Undo’, together with a message for notifying a DMB viewing-available time period. Also, the control unit 105 controls an initial screen for the phone function to be displayed on the display unit 106, in which the initial screen for the phone function includes a message for notifying a communication-available time period and a DMB viewing-available time period and either a movable bar for enabling the user to set a time division ratio between the two functions or a menu screen for enabling the user to directly input a minimum communication-available time period. In addition, the control unit 105 compares information read by the battery information reading unit 102 with the battery characteristic table stored in the memory 108 and calculates a DMB viewing-available time period or a communication-available time period on the basis of current remaining battery capacity.

The current communication-available time period is shown to the user through the display unit 106 upon user request. Also, the control unit 105 controls the general operation of the DMB receiving unit 103 and the phone transmission/reception unit 104. The key input unit 107 generates a key signal corresponding to a key pressed or selected by the user, and outputs the generated key signal to the control unit 105.

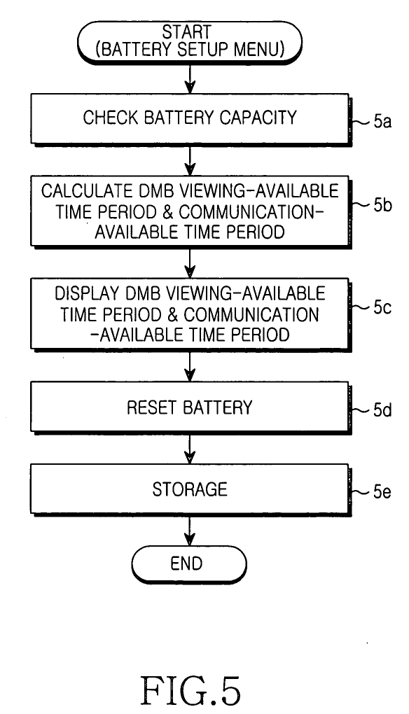

FIG. 5 is a flowchart illustrating a battery setup process for controlling the consumption of battery power using a battery setup menu according to an embodiment of the present invention. In step 5a, the control unit 105 checks the current battery capacity by detecting the voltage and current of the battery 101 using the battery information reading unit 102. In step 5b, the control unit 105 calculates a current DMB viewing-available time period and a current communication-available time period on the basis of the current battery capacity checked in step Sa.

In step 5c, the control unit 105 controls the calculated DMB viewing-available time period and communication-available time period to be displayed on the display unit 106. That is, as described above with reference to FIG. 1A, the capacity portion assigned for DMB viewing and the capacity portion assigned for communication from among the remaining battery capacity are identified by a movable bar in a linear adjustment slit displayed on a screen, thereby allowing the user to easily recognize them.

When the user having seen a screen as shown in FIG. 1A wants to reset the first amount assigned for DMB viewing and the second amount assigned for communication on the basis of remaining battery capacity as another ratio, the control unit 105 senses the input for battery setup input by the user in step 5d. In this case, the user can set the first amount assigned for DMB viewing and the second amount assigned for communication from among remaining battery capacity according to user preference by moving the bar in the linear adjustment slit displayed on the display unit 106 using an input unit such as a specific key of the key input unit 107.

In step 5e, the control unit 105 stores the battery setup information in the memory 108.

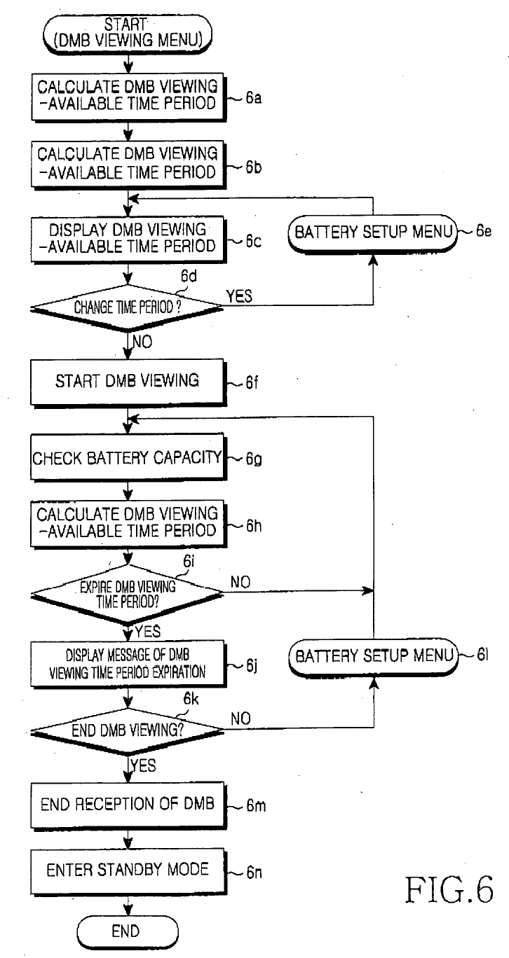

FIG. 6 is a flowchart illustrating a method for controlling DMB viewing according to an embodiment of the present invention, which can control battery power. In step 6a, the control unit 105 checks the current battery capacity by detecting voltage and current. In step 6b, the control unit 105 calculates a current DMB viewing-available time period on the basis of the current battery capacity, as checked in step 6a.

In step 6c, the control unit 105 displays the calculated DMB viewing-available time period on the display unit 106. In this case, the calculated DMB viewing-available time period may be displayed as a screen such as that shown in FIG. 2, which enables the user to understand in advance a time period during which the user is allowed to view the DMB.

In step 6d, the control unit 105 checks whether there is a request to change a set period of time. As explained above, the user having been provided a screen as shown in FIG. 2 may want to increase or decrease the DMB viewing-available time period.

When the control unit 105 senses the user's time change request (i.e., the user's battery reset request), the control unit 105 displays a battery setup menu screen on the display unit 106 in step 6e, completes the operations as described with reference to FIG. 5, and then returns to step 6c. Herein, “sensing the user's battery reset request” means, for example, that the user selects the ‘2. Reset battery’ item on the menu screen shown in FIG. 2.

Although not shown, it is possible to display a message asking the user whether the user wants to reset the use of battery, on the display unit 106.

Meanwhile, when the user selects the “1. Start viewing” item on the menu screen shown in FIG. 2, the control unit 105 senses the selection in step 6f. In this case, when the DMB viewing-available time period is zero, it is impossible to select the “1. Start viewing” item.

Steps 6g to 6i represent a procedure for checking whether a predetermined DMB viewing-available time period is finished. That is, the control unit 105 checks the current battery capacity through the detection of voltage and current in step 6g and calculates a DMB viewing-available time period in step 6h. In step 6i, the control unit 105 determines whether the DMB viewing-available time period has expired. As a result, when the DMB viewing-available time period has not expired, the control unit 105 returns to step 6g.

In contrast, when the DMB viewing-available time period expires, the control unit 105 proceeds to step 6j, in which the control unit 105 controls a DMB viewing time period expiration message to be displayed on the display unit 106. For instance, the control unit 105 may display, as shown in FIG. 3, messages such as “DMB viewing time period expires.” and “Continue to view?” together with button icons representing “Yes” and “No” on the display unit 106.

Then, the control unit 105 checks whether the user wants to end the DMB viewing in step 6k. That is, the control unit 105 checks that the user selects one of the “Yes” and “No” button icons.

When the control unit 105 senses that the user selects the “Yes” button icon, the control unit 105 controls the DMB receiving unit 103 to end the reception of DMB in step 6m and changes the mode of the terminal into the standby mode (e.g., a phone mode) in step 6n.

In contrast, when the control unit 105 senses that the user selects the “No” button icon, the control unit 105 displays a battery setup menu screen on the display unit 106 in step 6l to perform the operations as described with reference to FIG. 5 and returns to step 6g.

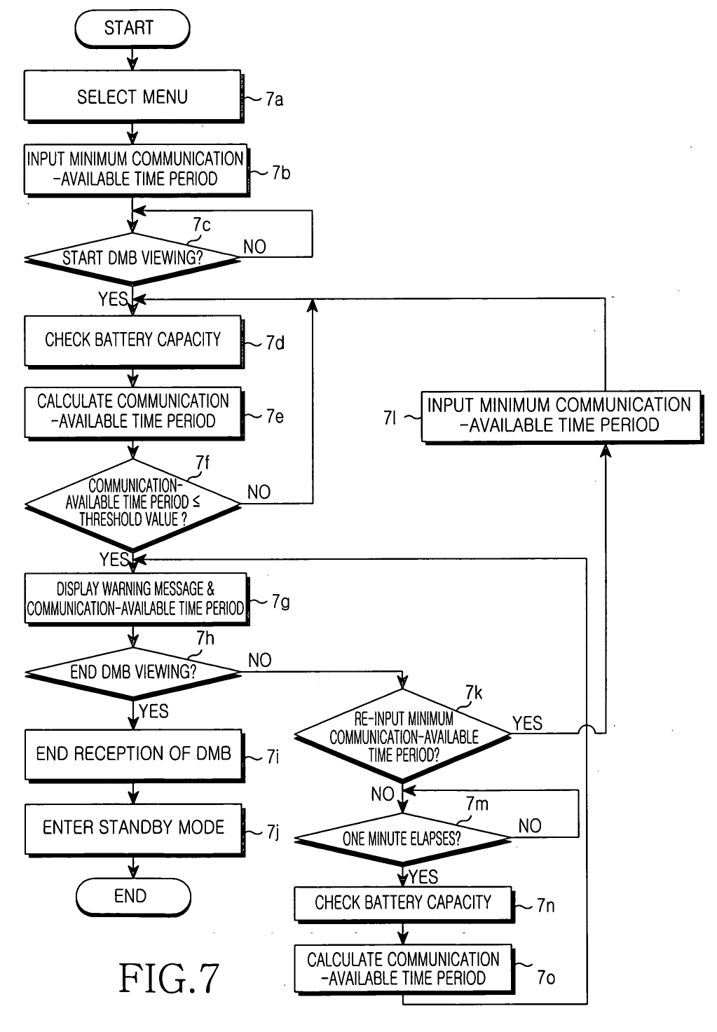

FIG. 7 is a flowchart illustrating a method for controlling DMB viewing according to another embodiment of the present invention, which can control battery power. In step 7a, the control unit 105 senses that the user selects a menu item to set a minimum communication-available time period and controls display unit 106 to display a screen as shown in FIG. 1B. In step 7b, when the user inputs a minimum communication-available time period, the control unit 105 senses the input and stores the sensed information in the memory 108.

In step 7c, the control unit 105 checks whether the user starts the DMB viewing. As a result, when the control unit 105 senses that the DMB viewing starts, the control unit 105 checks the current battery capacity through the battery information reading unit 102 in step 7d. In step 7e, the control unit 105 calculates a communication-available time period on the basis of the checked current battery capacity. In step 7f, the control unit 105 checks whether the calculated communication-available time period is equal to or less than a threshold value (i.e., the minimum communication-available time period stored in memory 108). When the calculated communication-available time period is more than the threshold value, the control unit 105 returns to step 7d. In contrast, when the calculated communication-available time period is equal to or less than the threshold value, the control unit 105 proceeds to step 7g, in which the control unit 105 displays a communication-available time period together with a warning message. In step 7h, the control unit 105 checks whether an end command for the DMB viewing is input by the user. As a result, the control unit 105 senses that the end command for the DMB viewing is input, the control unit 105 controls the DMB receiving unit 103 to end the reception of DMB in step 7i and changes the mode of the terminal to the standby mode in step 7j.

In contrast, as a result of step 7h, when the control unit 105 determines that the end command for the DMB viewing is not input by the user, the control unit 105 checks whether the user intends to re-input the minimum communication-available time period in step 7k. In this case, when the control unit 105 senses the user's re-input request, the control unit 105 displays the menu screen (which is shown in FIG. 1B) for inputting the minimum communication-available time period in step 7l so as to enable the user to re-input the minimum communication-available time period and then returns to step 7d. Herein, sensing the user's re-input request for the use of battery may be performed in such a manner that the control unit 105 displays a message such as “Want to re-input the minimum communication-available time period?” and determines whether a predetermined key signal is input by the user.

When the control unit 105 senses that the user does not want to re-input the minimum communication-available time period in step 7k, the control unit 105 checks whether a predetermined period of time (e.g., one minute) elapses in step 7m. As a result, when the predetermined period of time elapses, the control unit 105 checks the current battery capacity in step 7n, calculates a communication-available time period in step 7o, and then returns to step 7g. This is performed for the purpose of notifying the user by providing a warning message and the current communication-available time period at every predetermined time interval.

As described above, in the mobile communication terminal according to the present invention, the user can set the entire battery capacity equally or differentially according to at least two functions so that each function may consume only the portion of battery capacity assigned for the relevant function. Accordingly, it is possible to prevent a function from consuming too much battery power, that may result in the terminal not being able to perform another function.

In addition, in the case of a portable phone to which the present invention is applied, when a predetermined time period set in advance by the user has passed while the user is viewing DMB, the DMB is automatically cut off so as to enable the terminal to perform only the phone function. Therefore, it is possible to reserve some battery power for the normal phone function, allowing the user can view the DMB at ease, i.e. without worrying about consuming too much battery power rendering the phone rendered unanswerable.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A battery consumption control apparatus for a terminal which has at least two functions and is supplied with electric power from a battery, the battery consumption control apparatus comprising:
a battery information reading unit for reading battery capacity;
a memory for storing information about function executable time periods assigned to at least two functions, equally or differentially, within a time period available for a capacity range of the battery; and
a control unit for controlling a selected function and for allowing the selected function to be performed for only a time period corresponding to the function executable time period information.

2. The battery consumption control apparatus as claimed in claim 1, further comprising a user interface unit for selecting a function or for inputting information relating to the executable time period.

3. The battery consumption control apparatus as claimed in claim 2, wherein the user interface unit further comprises a display unit for visually displaying the selected function and the information relating to the executable time period for the selected function.

4. The battery consumption control apparatus as claimed in claim 3, further comprising a Digital Multimedia Broadcasting (‘DMB’) reception unit for receiving DMB and a transmission/reception unit for a phone function, wherein the control unit checks a relevant executable time period in the memory when a DMB function is selected by a user, permits the DMB to be received only for the relevant executable time period, and automatically changes to a standby mode for the phone function when the relevant execution time period elapses.

5. The battery consumption control apparatus as claimed in claim 4, wherein the control unit controls a menu screen to be displayed on the display unit, the menu screen providing notification of expiration of a DMB viewing-available time period, asking a question of whether the user wants to continuously view the DMB and enabling the user to respond to the asked question.

6. The battery consumption control apparatus as claimed in claim 4, wherein the control unit controls an initial screen for the DMB function to be displayed on the display unit, in which the initial screen includes user selection icons for ‘Start viewing’, ‘Reset battery’ and ‘Undo’, and a message for notifying the DMB viewing-available time period.

7. The battery consumption control apparatus as claimed in claim 4, wherein the control unit controls an initial screen for the phone function to be displayed on the display unit, in which the initial screen displays a communication-available time period, a DMB viewing-available time period and a movable bar, which enables a user to set a ratio between the two time periods.

8. The battery consumption control apparatus as claimed in claim 4, wherein the control unit controls a screen for inputting a minimum communication-available time period for the phone function to be displayed on the display unit, calculates the communication-available time period corresponding to remaining battery capacity by checking remaining battery capacity after DMB viewing starts, and stops an operation of the DMB reception unit when the calculated communication-available time period is equal to or less than the minimum communication-available time period.

9. The battery consumption control apparatus as claimed in claim 8, wherein the display unit displays a warning message when the calculated communication-available time period is equal to or less than the minimum communication-available time period.

10. A battery consumption control apparatus for a terminal which has a first function and a second function and is supplied with electric power from a battery, the battery consumption control apparatus comprising:
a battery information reading unit for determining battery capacity;
a memory for storing a battery characteristic table; and
a control unit for calculating an executable time period for the second function, by comparing the battery characteristic table, battery capacity determined by the battery information reading unit and a minimum executable time period for the first function when the minimum executable time period for the first function is input by a user, and for controlling the second function to be executed only for the calculated executable time period allowed for the second function when the second function is selected by the user.

11. A method for controlling battery consumption in a terminal which has a first function and a second function and is supplied with electric power from a battery, the method comprising:
checking current battery capacity;
distributing a time period available for the current battery capacity to a first function executable time period and a second function executable time period;
checking battery capacity at a predetermined time interval upon execution of the selected one of the first and second functions;
calculating an executable time period for the selected function corresponding to the calculated battery capacity; and
ending the execution of the selected function when the calculated executable time period is identical to the distributed executable time period of the selected function.

12. The method as claimed in claim 11, further comprising:
checking whether the user requests the selected function to be continuously executed when the calculated executable time period is identical to the distributed executable time period of the selected function s; and
redistributing a time period available for the current battery capacity to a first function executable time period and a second function executable time period when sensing a command for continuous execution of the selected function.

13. A method for controlling battery consumption in a terminal which has a first function and a second function and uses a battery, the method comprising:
inputting a minimum executable time period for the first function;
checking battery capacity at a predetermined time interval when execution of the first function starts and calculating an executable time period for the first function corresponding to the checked battery capacity; and
ending the execution of the first function when the calculated executable time period for the first function is less than the minimum executable time period.

14. The method as claimed in claim 13, further comprising:
checking whether the user requests the first function to be continuously executed when the calculated executable time period for the first function elapses; and
inputting a new minimum executable time period for the first function within a time period available for a current battery capacity range when sensing a command for continuous execution of the first function.

15. The method as claimed in claim 14, further comprising:
checking battery capacity at every predetermined time interval when the command for continuous execution of the first function is not sensed and calculating an executable time period for the first function corresponding to the checked battery capacity; and
displaying the calculated executable time period for the first function and a warning message.
